(19) United States
(12) Patent Application Publication
(10) Pub. No.: US 2003/0010215 A1
(43) Pub. Date: Jan. 16, 2003

(54) Thermal coffee/tea carafe

(76) Inventor: Lori Burkholder, Cape Charles, VA (US)

Correspondence Address: Lori Burkholder, 314 PHILADELPHIA AVE., TAKOMA PARK, MD, 20912, US

(21) Appl. No.: 09/904,110

(22) Filed: Jul. 11, 2001

(51) Int. Cl. A47J 31/00; A23F 5/00

(52) U.S. Cl. 99/285; 99/323.3

(57) ABSTRACT

The present invention is a thermal coffee/tea carafe with an internal heat sensor device capable of indicating the temperature of the contents on a monitor on the lid or other exterior location of the vessel.

### FIELD OF THE INVENTION

The present invention relates in general to thermal beverage containers and more specifically to a high-impact plastic, triple-layer insulation carafe comprised of a thermal core, polyurethane insulation, and an unbreakable or durable polycarbonate lining, which comes in various sizes and colors with matching cups and saucers.

### BACKGROUND OF THE INVENTION

Commercial and domestic food servers alike are constantly confronted with the pervasive dilemma of providing and maintaining hot beverages at those “piping hot” temperatures capable of most convincingly conveying the sense of freshness and palatability found most satisfying to their consumers. It seems that the commercial market plateaued when the industry standard of stainless steel dispensers and matching coffee carafes with removable lids were manufactured. On the domestic front, some designers in the art have conceptualized versions of food/beverage containers which monitor temperature.

Although there are a number of variations on the coffee carafe, none of them specifically address an adequate means to determine the temperature of the liquid contents without removing the lid. This modification would allow restaurant servers to determine the temperature of the liquid at a glance and can ensure their customers get a fresh, hot cup of coffee or tea. Additionally, there is a need to reduce the potential for bums and injuries resulting from drinking beverages which are too hot.

PCT Publication No. WO 85/01202, issued to Wandel on Mar. 28, 1985, is for an insulated plastic coffee pot containing an inner glass balloon to house the beverage and a pouring spout. This invention has the appearance of a traditional coffee pot and does not provide any means of determining temperature.

U.S. Pat. No. 283,581, issued to Laslo on Apr. 29, 1986, is for an ornamental design of a coffee pot featuring a raised floral pattern. Laslo's invention is purely decorative and unlike the present invention, does not anticipate any means of determining temperature.

U.S. Pat. No. 292,162, issued to Zimmermann on Oct. 6, 1987, for an ornamental design of an insulated jug with a handle does not anticipate any means of determining temperature.

U.S. Pat. No. 328,546, issued to Unger on Aug. 11, 1992, for ornamental design of a coffee pot with lid does not anticipate any means of determining temperature.

U.S. Pat. No. 5,229,751, issued to Chandler et al. on Jul. 20, 1993, is a perishable fluid container which includes a timing mechanism extending from the handle into the cavity of the pot to determine freshness of the contents which it reflects back onto the handle. Although this design performs a similar function to that of the present invention, it is a modification of the standard glass coffee pot intended to be a receptacle for freshly made coffee and is not for the thermal storage and service of the same. Additionally, it does have a mechanism which times the duration the coffee was left in the pot, but has no means to determine the temperature of the contained liquid.

U.S. Pat. No. 346, 525, issued to Littmann on May 3, 1994, for an ornamental design for a beverage container, is not intended for hot beverages and as such, does not anticipate any means for determining temperature monitoring indicia.

U.S. Pat. No. 375,016, issued to Ullmann on Oct. 29, 1996, for ornamental design of a thermal coffee pot and as such, does not anticipate any means of determining temperature or monitoring indicia.

U.S. Pat. No. 5,568,735, issued to Newkirk on Oct. 29, 1996, for a refrigerated food or beverage container with a thermometer for determining the temperature at which contents are being chilled, did not anticipate or use materials suitable for hot liquids.

Though some earlier patents attempt to measure the relative “freshness” of a beverage with a timing device or the temperature of refrigerated contents, none of the related art specifically contemplates an external temperature indicator capable of maintaining an accurate reading of the temperature of the hot or cold beverage from the inside of the container.

### SUMMARY OF THE INVENTION

Therefore, a need has developed for a coffee carafe with an external temperature gauge capable of reflecting the temperature of the liquid contents in hot beverage containers. The present invention is a thermometer associated with the lid. A tube is attached to the bottom side of the lid and extends internally to the base of the container. This tube houses a heat sensor device which reflects the temperature of the contents on the outside of the lid. Preferably, a conventional temperature determining system will associate colored lights with the determined temperature. The reading could also be electronic using a standard method. An LCD display panel would be located on the top of the lid. A reading of 130 degrees would be indicated by a green light. This temperature is hot, but still drinkable. A reading of 110 degrees would be associated with a yellow light and a reading of 100 degrees, which indicates that the beverage is beginning to get cold would have a red light. Embodiments of the carafe would be comprised of three layers of durable polymers suitable for utilization in a thermal-sensitive configuration, come in different colors and may have matching cups and saucers.

### BRIEF DESCRIPTION OF THE DRAWING

FIG. 1 is a side elevational cross-section view of the present invention.

### DETAILED DESCRIPTION OF THE PREFERRED EMBODIMENT(S)

The present invention is a carafe that stores hot beverages with the intension of keeping them hot and fresh-tasting. The temperature determining mechanism makes it possible to read the temperature of the liquid accurately and conveniently. It has a flat bottom surface upon which it can rest. The lower half of the carafe is rounded but then narrows toward the top to create a “neck-type” of region before slightly widening again. The carafe is furnished with a standard handle and spout to facilitate pouring a beverage out of the container.

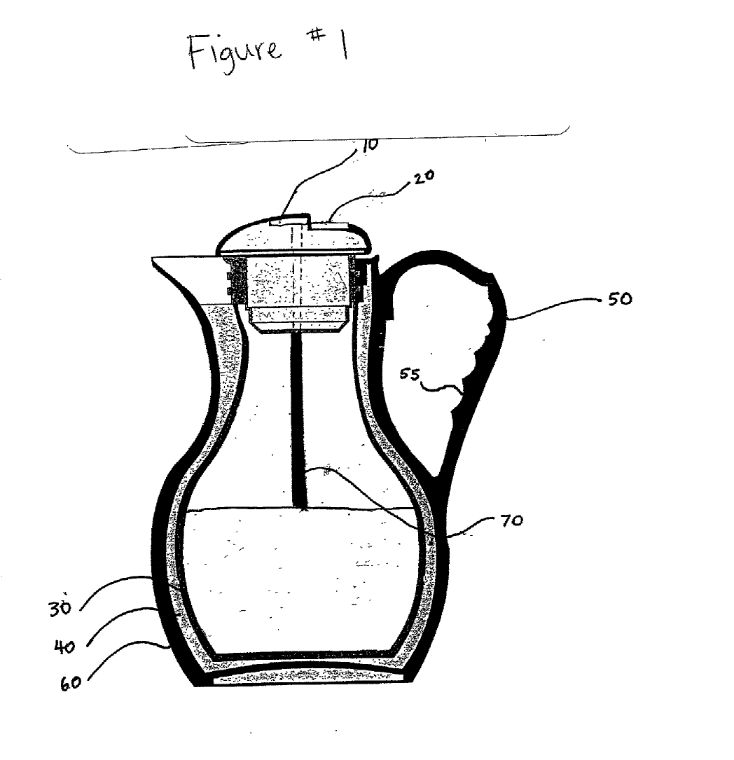

With reference to FIG. 1, the height of the preferred embodiment of the carafe (80) is approximately 11 inches, while the width is approximately 6 ½ inches. The diameter of the mouth of the container is 6 inches. The conventional spout can be cleaned with soap and a bottle brush with ease.

The present invention (80) can preferably contain 64 fluid ounces for distribution of a hot beverage amongst a quantity of individuals. A handle extends nearly horizontally from the upper portion of the carafe and then projects downward to the lower portion of the container. There is an ergomatic region (55) of the lower half of the handle to facilitate handling and pouring the beverage from the container.

A composition of materials will be employed in order to provide proper insulation to the liquid. The assembly and composition of these materials will ensure a thermal effect to achieve the goal of the present invention. In order to achieve this triple-layer thermal effect, one possible embodiment would be the grip handle (50) and the outer surface of the carafe being fabricated out of a durable, high impact plastic; the vessel insulated with a suitable polyurethane material (40) and the interior lining (30) consisting of a suitable, durable, non breakable polycarbonate material suitable for containing hot beverages without leaching toxins. A possible embodiment of the visible temperature display monitor (10) would appear on the screw-top lid (20) in clear plastic. The lid itself (20) is a twist on/off that seals tightly to improve insulation and prevent leakage or spills.

The preferred embodiment of the present invention has a temperature gauge having a hollow tube extending from the top of the lid to the bottom of the vessel, which comprises a polycarbonate material similar to that of the lining (30) and which is suitable for housing and/or guiding the temperature sensor (70) that ultimately relays the heat reading to the surface of the temperature display monitor (10) on the lid (20) by a standard electronic temperature determining mechanism.

The preceding descriptions should not be construed as limitations of the invention by any measure as numerous improvements (including variations on materials used, size and shape, design and placement of the temperature gauge and temperature indicia) on the current invention and the description of the preferred embodiments can be envisioned by those skilled in the art. It is to be understood that the present invention is not limited to the embodiments described above, but encompasses any and all embodiments within the scope of the following claims.

I claim:

1. A hot beverage container, comprising:
a main body having the ability to insulate,
a lid in removable communication with said main body,
an LCD display in said lid which reads and displays the temperature of the hot beverage,
a handle attached to said body; and
a flat bottom region to allow said main body to be set on a table or other flat surface.
